(19) United States
(12) Patent Application Publication
(10) Pub. No.: US 2017/0027662 A1
(43) Pub. Date: Feb. 2, 2017

(54) Composite Capsule and Method for Producing a Composite Capsule

(71) Applicant: Transcodent GmbH & Co. KG, Kiel (DE)

(72) Inventors: Frederic Sobina, Kiel (DE); Lars Tiekenheinrich, Kiel (DE)

(21) Appl. No.: 15/213,852

(22) Filed: Jul. 19, 2016

(30) Foreign Application Priority Data
Jul. 31, 2015 (DE) 102015214697.9

(51) Int. Cl. A61C 5/06; B29C 65/16; B29C 65/48; B29C 65/08

(52) U.S. Cl. CPC A61C 5/066; A61C 5/062; B29C 65/08; B29C 65/16; B29C 65/48; B29L 2031/7174

(57) ABSTRACT

In a method for producing a composite capsule, a liquid or pasty substance, in particular a dental composition, is introduced into a receiving space of a capsule part. The receiving space is surrounded by a capsule wall, which has a discharge opening. A plunger is introduced into the receiving space and a capsule extension leads up to the capsule part. A connection is established between the capsule part and the capsule extension. With a corresponding composite capsule, it becomes possible to dispense an increased volume of the substance from the composite capsule.

### BACKGROUND

The invention relates to a method for producing a composite capsule. In the method, a liquid or pasty substance, in particular a dental composition, is fed into a receiving space of a capsule part. The receiving space of the capsule part is surrounded by a capsule wall, which has a discharge opening. The invention additionally relates to a composite capsule.

Such composite capsules serve to dispense a dental composition, as is used, for instance, to fill cavities in teeth, purposefully at a desired location in the oral cavity of a patient. For the dispensing of the dental composition, the composite capsule is inserted into a standardized compule gun. The standardized compule gun comprises a ram, with which a plunger disposed in the composite capsule is pushed forward, so that the dental mass is discharged via the discharge opening and can be used by the dentist at the desired location.

The volume of dental composition which can be dispensed according to this method is determined by the ram travel and the cross section of the receiving space. The ram travel is fixed by the design of the dispensing gun. Likewise the cross section of the receiving space cannot be freely chosen, since the composite capsule must be consistent with the capsule receptacle of the dispensing gun. For this reason, the quantity of dispensed dental composition cannot be increased according to choice.

### SUMMARY

A composite capsule and a method for producing a composite capsule is provided with which a greater quantity of dental composition can be dispensed.

A plunger is introduced into the receiving space and a capsule extension is led up to the capsule part. A connection is established between the capsule part and the capsule extension.

The capsule extension ensures that the cross section of the receiving space is no longer directly restricted by the capsule receptacle of the dispensing gun. That is to say, it is no longer necessary that the capsule part forming the receiving space is itself inserted into the capsule receptacle of the dispensing gun. Rather, the connection between the composite capsule and the dispensing gun can be established via the capsule extension. The capsule extension can thus correspond in its cross section to the hitherto customary composite capsules. The capsule part into which the capsule extension is introduced can have a larger diameter, which leads to a correspondingly increased quantity of dental composition which is able to be dispensed with a defined ram travel.

The volume of the substance fed into the receiving space is preferably greater than 0.2 ml, further preferably greater than 0.3 ml, and further preferably greater than 0.5 ml. More than 1 ml of the substance is generally not dispensed. The volume is thus greater than with previous composite capsules.

The substance is preferably fed into the receiving space via the same opening by which the plunger also is introduced into the receiving space. This opening can be disposed at an opposite end of the composite capsule to the discharge opening. In accordance with that motional direction of the substance which emerges from the arrangement of these two openings, that end of the composite capsule at which the discharge opening is disposed is referred to as the front end. The opposite end of the composite capsule is the rear end.

The capsule part can have a portion in which the capsule wall cylindrically surrounds the receiving space. This portion of the capsule wall can be designed to cooperate with a shell surface of the plunger. The plunger should be dimensioned such that it forms a seal with the capsule wall.

The cylindrical portion of the capsule wall can extend up to the rear end of the capsule part. It is also possible for the capsule part to have at the rear end a slight widening in order to facilitate the introduction of the plunger and the capsule extension. The widening extends preferably over no more than 10%, and further preferably over no more than 5% of the length of the capsule part. Any dispensing tip which connects to the discharge opening of the capsule part is left out of account when determining the length of the capsule part. The cylindrical portion of the capsule wall extends preferably over at least 50%, further preferably over at least 70%, and further preferably over at least 80% of the length of the capsule part.

In order to be able to connect the capsule extension to the capsule part, the capsule extension is preferably led up to the capsule part such that a face of the capsule extension bears against a face of the capsule part. There are different options as to which faces these can be. For instance, it is possible for a rear end face of the capsule part to bear against a front end face of the capsule extension. It is also conceivable for an outer shell surface of the capsule part to bear against a suitably shaped face of the capsule extension. In a preferred embodiment, a front portion of the capsule extension is introduced into the receiving space, so that a shell surface of the capsule extension bears against the capsule wall surrounding the receiving space. It is also possible for a plurality of these faces to bear one against another.

If a front portion of the capsule extension is introduced into the receiving space, the capsule extension expediently has an outer face consistent with the capsule wall. In particular, the capsule extension can have a cylindrical shell surface, the external diameter of which is consistent with the internal diameter of the cylindrical portion of the capsule wall. The capsule extension then bears with its outer face full-facedly against the capsule wall and the establishment of the connection between the two parts is facilitated.

For the connection to the capsule part, it is sufficient if only that front portion of the capsule extension which is introduced into the receiving space is shaped such that it is consistent with the capsule part. The distance by which the capsule extension is introduced into the receiving space is preferably no longer than 30%, further preferably no longer than 20%, further preferably no longer than 10% of the length of the capsule part.

In a preferred embodiment, the cylindrical shell surface of the capsule extension extends up to an outwardly projecting supporting surface, which is designed to cooperate with a counter supporting surface of the dispensing gun. The supporting surface is preferably oriented such that it transmits a counterforce to the force of the ram. The supporting surface can be configured on an annular projection which extends round about the periphery of the capsule extension. The annular projection can form the rear end of the capsule extension. The annular projection and the cylindrical shell surface are preferably dimensioned such that they are consistent with the capsule receptacle of the dispensing gun.

Inside the capsule extension can be configured a duct, which forms a connection between the rear end of the composite capsule and the receiving space. The duct can have a cylindrical wall. The cylindrical wall can extend over the entire length of the capsule extension. At its rear end, the wall can have a slight widening in order to facilitate the introduction of the ram of the dispensing gun.

In the duct can be disposed a transmission part, which is designed to transmit to the plunger a force exerted by the ram. The transmission part can be integrally connected to the plunger. Preferredly the transmission part extends over at least 70%, preferably at least 80%, and further preferably at least 90% of the length of the capsule extension. If the transmission part reaches up to the rear end, or at least almost up to the rear end of the capsule extension, the ram travel of the dispensing gun can be fully utilized.

The discharge opening at the front end of the capsule part can pass into a dispensing tip. The dispensing tip has a through duct, through which the substance is pressed when the plunger moves forward in the capsule part. The dispensing tip can form an angle between, for instance, 30° and 60° with the longitudinal axis. In one embodiment, the dispensing tip is provided with a hollow needle, which forms the duct for the substance. The capsule part and/or the extension can be produced as a plastics injection molded part. The hollow needle consists of metal. If there is no hollow needle, the duct extends directly within the dispensing tip.

For the introduction of the plunger and the capsule extension into the receiving space, there are several options. One option is that in a first step the plunger is introduced as a separate part into the receiving space. In a second step, the front end of the capsule extension is introduced into the receiving space, wherein, where appropriate, the plunger is pushed so far forward that direct contact is made between the outer face of the capsule extension and the capsule wall. This procedure has the drawback that at the same time the capsule extension must be threaded onto the transmission part should the transmission part be fixedly connected to the plunger.

In another embodiment, in a first step the plunger and the capsule extension are joined together by the introduction of the transmission part of the plunger into the duct of the capsule extension. In a second step, the plunger and the capsule extension are introduced jointly into the receiving space.

In both cases, the plunger and the capsule extension should be inserted into the receiving space at least to the point where direct contact is made between the capsule extension and the wall of the capsule part. On the other hand, the plunger and the capsule extension should be introduced only to the point where, in the front portion of the capsule part, there remains sufficient space for the substance. The plunger is disposed between the front end of the capsule extension and the discharge opening of the capsule part. The plunger is thus enclosed between the capsule extension and the discharge opening and cannot be removed from the receiving space as long as the capsule extension is inserted in the receiving space.

The connection between the capsule extension and the capsule part is established in a suitable manner. An integral connection between the capsule extension and the capsule part is preferred. For instance, the connection can be established by ultrasonic welding or laser welding. A bonding together of the two components is also possible. The connection is preferably established between the outer face of the capsule extension and the capsule wall, wherein the connection extends without interruption over the whole of the periphery of the capsule extension.

The invention additionally relates to a composite capsule for a liquid or pasty substance, in particular for a dental composition, as can be produced according to the method. The composite capsule comprises a capsule part which encloses a receiving space with a capsule wall, wherein the capsule wall is provided with a discharge opening and wherein a plunger is disposed in the receiving space. The composite capsule comprises a capsule extension, which is connected to the capsule part. In a preferred embodiment, a front portion of the capsule extension is inserted in the receiving space.

The invention additionally relates to a system comprising a composite capsule of this kind and a dispensing gun. The dispensing gun can be equipped with a capsule receptacle for the composite capsule, wherein the capsule receptacle has a counter supporting surface cooperating with the supporting surface of the composite capsule. When the composite capsule is inserted in the capsule receptacle, pressure can be exerted on the plunger of the composite capsule with a ram of the dispensing gun, so that the substance is discharged at the front end of the composite capsule. An end face of the ram is here brought into contact with a rear face of the transmission part disposed in the capsule extension, in order to exert the pressure. By means of the counter supporting surface and the supporting surface, the composite capsule is held in position counter to the pressure of the ram.

The counter supporting surface is preferably provided with a recess, through which the composite capsule can be guided in the radial direction for insertion of the composite capsule into the capsule receptacle. The capsule receptacle can here be designed such that it embraces the composite capsule in the manner of a snap fit.

The invention additionally relates to a method for dispensing a dental composition. Here the composite capsule is inserted into the suitable capsule receptacle of the dispensing gun and a mechanism is actuated for the movement of the ram in the direction of the composite capsule. The ram then moves into the capsule extension and exerts pressure on the plunger and the dental composition behind it, which moves in the direction of the discharge opening. The actuation of the mechanism for the movement of the ram is proportioned such that a suitable quantity of dental composition is discharged from the discharge opening.

The methods can be refined with further features described within the context of the composite capsule or the system. The composite capsule and the system can be refined with further features described within the context of the methods.

### BRIEF DESCRIPTION OF THE DRAWINGS

The invention is described below with reference to the appended drawings on the basis of advantageous embodiments, wherein:

FIG. 1 shows a system comprising a dispensing gun and a composite capsule;

FIG. 2 shows a detail from FIG. 1 in an enlarged view from above;

and

FIG. 3 shows a composite capsule.

### DETAILED DESCRIPTION

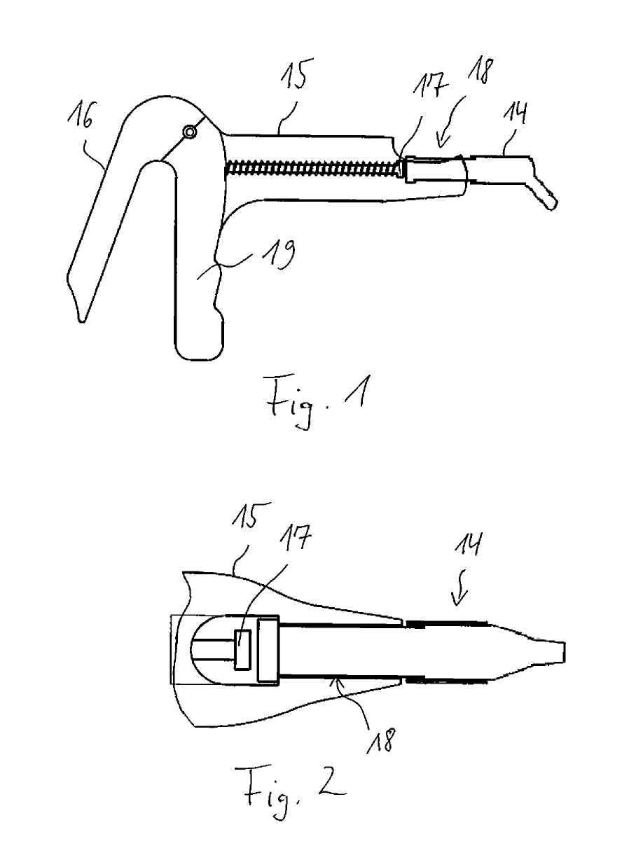

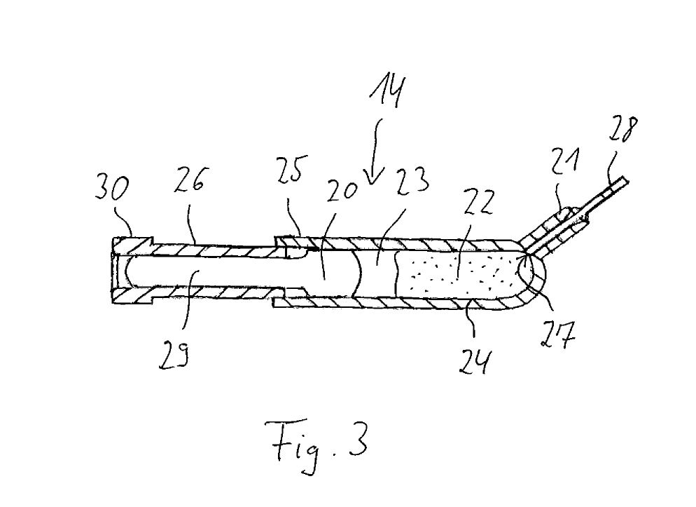

A system comprises according to FIGS. 1 and 2 a composite capsule 14 and a dispensing gun 15. The dispensing gun 15 is equipped with a mechanism 16, by which a ram 17 is pushed in the direction of a capsule receptacle 18 disposed at the front end of the dispensing gun 15. Furthermore, the dispensing gun 15 comprises a handle 19, which extends in the radial direction. The end face of the ram 17 is circular and has a diameter which is somewhat smaller than the opening at the rear end of the composite capsule 14.

The ram 17 and the composite capsule 14 are arranged such that, upon actuation of the mechanism 33, the ram 17 enters into the composite capsule 14 and pressure is exerted on a plunger 20 disposed therein. The plunger 20 is thereby moved in the direction of a dispensing tip 21 of the composite capsule 14 and thereby conveys the dental composition 22 present in the receiving space likewise in the direction of the dispensing tip 21. If the plunger 20 is pushed by the ram 17 sufficiently far in the direction of the dispensing tip 21, the dental composition 22 is discharged at the front end of the dispensing tip 21. For the dentist, it is easy to dispense dental composition in this way purposefully in the mouth of a patient.

According to FIG. 3, the composite capsule 14 is composed of a capsule part 25 and a capsule extension 26. The capsule part 25 comprises a capsule wall 24, which cylindrically comprises a receiving space 23. In the receiving space 23 is contained the dental composition 22. In the direction of its rear end, the receiving space 23 is closed off with a plunger 20, which forms a seal with the capsule wall 24. If the plunger 20 is pushed in the direction of the front end of the composite capsule 14, then the dental composition 22 moves through a discharge opening 27 and a hollow needle 28 disposed in a dispensing tip 21 and is discharged at the front end of the hollow needle 28.

The plunger 20 is integrally connected to a transmission part 29 which extends in the direction of the rear end of the composite capsule 14. The transmission part 29 is disposed inside the capsule extension 26. The capsule extension 26 encloses an opening at the rear end of the composite capsule 14, through which the rear end of the transmission part 29 is accessible. When the composite capsule 14 is inserted in the dispensing capsule 15, the ram 17 penetrates through the opening into the inside of the capsule extension 26. The ram 17 can in this way exert pressure on the rear face of the transmission part 29 and move the plunger 20 forward.

The capsule extension 26 has a cylindrical outer face, the diameter of which is consistent with the diameter of the receiving space 23 enclosed by the capsule wall 24. The capsule extension 26 is a small piece introduced into the receiving space 23, so that the outer face of the capsule extension 26 bears full-facedly against the capsule wall 24. The capsule extension 26 and the capsule part 25 are fixedly connected to each other by ultrasonic welding. The capsule part 25 and the capsule extension 26 thus form a unitary housing of the composite capsule 14.

At the rear end of the composite capsule 14, an annular projection 30 extends around the periphery of the composite capsule 24. The projection 30 is consistent with the standardized capsule receptacle 18 of the dispensing gun 15. The forward pointing face of the projection 30 cooperates as a supporting surface with a counter supporting surface of the dispensing gun 15.

Since the capsule part 25 has a larger diameter than the capsule extension 26 (which is consistent with the standardized capsule receptacle), the capsule part 25 has a receiving space 23 which has a cross section larger than customary composite capsules. The quantity of dental composition which can be dispensed with a given ram travel is thereby increased.

1. A method for producing a composite capsule, comprising the following steps:
a. introduction of a liquid or pasty substance into a receiving space of a capsule part, wherein the receiving space is surrounded by a capsule wall, which has a discharge opening;
b. introduction of a plunger into the receiving space and leading portion of a capsule extension up to the capsule part;
c. establishment of a connection between the capsule part and the capsule extension.

2. The method as claimed in claim 1, wherein a front portion of the capsule extension is introduced into the receiving space.

3. The method as claimed in claim 1, wherein the substance is fed into the receiving space in a volume which is greater than 0.2 ml.

4. The method as claimed in claim 1, wherein the capsule part has a portion in which the capsule wall cylindrically surrounds the receiving space.

5. The method as claimed in claim 4, wherein the capsule part has a length and the cylindrical portion extends over at least 50% of the length of the capsule part.

6. The method as claimed in claim 1, wherein the capsule extension has an outer face consistent with the capsule wall.

7. The method as claimed in claim 1, wherein the capsule part has a length and the capsule extension is introduced into the receiving space a distance which is preferably no longer than 30% of the length of the capsule part.

8. The method as claimed in claim 1, wherein the capsule extension has an outwardly projecting supporting surface, which is designed to cooperate with a counter supporting surface of a dispensing gun.

9. The method as claimed in claim 1, wherein inside the capsule extension is configured as a duct, which forms a connection between the rear end of the composite capsule and the receiving space.

10. The method as claimed in claim 9, wherein in the duct is disposed a transmission part, which is designed to transmit to the plunger a force exerted by a ram.

11. The method as claimed in claim 10, wherein the transmission part is integrally connected to the plunger.

12. The method as claimed in claim 1, wherein the connection between the capsule extension and the capsule part is established by at least one process selected from the group consisting of ultrasonic welding, laser welding and gluing.

13. A composite capsule for a liquid or pasty substance, comprising a capsule part which encloses a receiving space with a capsule wall, wherein the capsule wall is provided with a discharge opening, and wherein a plunger is disposed in the receiving space, which composite capsule comprises a capsule extension connected to the capsule part.

14. A system comprising a composite capsule as claimed in claim 13 and a dispensing gun, wherein the dispensing gun is equipped with a capsule receptacle for the composite capsule, which capsule receptacle has a counter supporting surface cooperating with an end face of the composite capsule, and wherein the dispensing gun comprises a ram, which is designed to exert pressure on the plunger of the composite capsule, so that the substance is discharged from the composite capsule.

15. The method of claim 1 wherein the liquid or pasty substance is a dental composition.

16. The method of claim 3 wherein said liquid or pasty substance is a dental composition.

17. The method as claimed in claim 2, wherein the substance is fed into the receiving space in a volume which is greater than 0.2 ml.

18. The method as claimed in claim 1, wherein the substance is fed into the receiving space in a volume which is greater than 0.3 ml.

19. The method as claimed in claim 1, wherein the substance is fed into the receiving space in a volume which is greater than 0.5 ml.

20. The method as claimed in claim 4, wherein the capsule part has a length and the cylindrical portion extends over at least 70% of the length of the capsule part.
